(19) United States
(12) Patent Application Publication
(10) Pub. No.: US 2003/0217855 A1
(43) Pub. Date: Nov. 27, 2003

(54) Wiring of a building using decorative molding as the wire routing media

(76) Inventor: Paul Kolostroubis, McKinney, TX (US)

Correspondence Address: PAUL KOLOSTROUBIS, 4206 WIDGEON CT., MCKINNEY, TX, 75070, US

(21) Appl. No.: 10/249,704

(22) Filed: May 1, 2003

Related U.S. Application Data
(60) Provisional application No. 60/319,260, filed on May 21, 2002.

(51) Int. Cl. H02G 3/04

(52) U.S. Cl. 174/48

(57) ABSTRACT

A method to neatly add wiring to a house avoiding the clattering that different types of wires cause. The back plane of this special molding serves as housing of all types of wiring and safely routes them throughout the house, at the specific destination point. A flat panel can be used to attach on the wall on one side and to sustain the wiring on the other. Methods to group the wires are suggested by either inserting the wires directly into the channels of the molding or the flat panel or by using a clear tube open on its side for ease of wire insertion.

### BACKGROUND OF INVENTION

It is common place for houses to have small networks of multiple personal computers. The hub that distributes the network cables to each personal computer in the home office can only be in one place and then the cables always end up in the way. The same goes for speaker cables, telephone/modem cables. . . . Another messy situation arises around the home theater/ entertainment center area. Speaker cables all over, under the carpet, along the wall, across the ceiling, under the sofa for those surround mode speakers. Fountain fixtures add elegance to any house but the wires needed to run the pump from the A/C outlet are an unsightly undesirable side effect.

This invention puts an end to the mess created by numerous wires existing between the PC and the wall outlets in an existing office. It can also provide painless networking to rooms adjacent to the “main office”. A whole house can be networked together, assuming aesthetically acceptable molding pieces exist in the market. Network cables, alarm cables, data cables for security cameras, bells, speakers can be nicely “routed” behind molding pieces, through specially manufactured “channels” that this invention proposes.

### SUMMARY OF INVENTION

The invention proposes the creation of special adaptive channels in the back of molding pieces (the part that mounts against the wall). There can be two flavors of implementing this idea. In the first method, these special channels serve as housing of the various wires and are engraved on the molding itself which, in turn, gets attached on the wall with the cables in those engraved channels. Furthermore, the loose wires can be housed in a plastic “wrap-around” housing that preferably snaps into the “channels” mentioned above. This “wrap-around” is clear, for easy inspection of the wires inside, and has a sideways opening for the wires to be inserted through. As a second flavor, a flat panel is used. This panel mounts against the wall and houses the various wires, in a snap in or “channelized” fashion. The decorative hollow molding pieces are then snapped on or screwed on the panel which is already mounted on the wall. The implementation of this idea is based on molding manufactured with polyurethane or similar material, but is not limited just to that. Wood molding can accommodate this invention easily by adding special padding to the edges of the wood molding so that it creates a hollow space where various cables can run through. As a matter of fact, the principles described in this document can be easily adapted to any molding material.

### BRIEF DESCRIPTION OF DRAWINGS

FIG. 1 displays the method where the molding itself houses the wires. In this cases the molding with the wires attach directly on the wall.

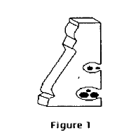

FIG. 2 displays the method where the molding itself has a hollow cavity. The wires themselves are housed into or onto the flat panel which attaches against the wall. The molding either snaps or screws on the panel.

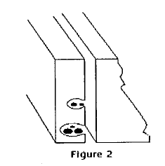

### DETAILED DESCRIPTION

This invention proposes an alternative way of wiring a house. Specifically, low voltage wiring is the most likely application candidate. Anything from speaker wires to personal computer networking wires, to telephone/modem cables but also electrical wall appliances. Any wire that needs to be hidden or organized can be grouped behind this new type of molding. This is accomplished by incorporating the hollow cavity space required by all the wires to be hidden into the molding apparatus itself.

For this to work, the molding could either be hollow and have snap on adapters that will accept the wires to be hidden, or, it could have pre-etched channels that can house the wires directly or indirectly. If the wires are to be housed directly then the wires are placed into those channels one by one or in groups, as they fit. In the case of indirect placement, the wires are first placed into a clear plastic tube(open on one side for easy wire insertion) and then this tube is inserted into the molding channel.

In yet another flavor, a flat panel that goes against the wall is the housing and “router” of the various wires. This flat panel attaches on the wall. The panel might be “channelized” just as the case of the molding explained above. The clear tube method for grouping the wires could also be used in this case. If the flat panel has snap on acceptors for the wires, then the molding has to be hollow so that the space required by the grouped wires is enough. After the wires are in place and the flat panel is secured on the wall, the molding can be attached on the flat panel by either screws or by snapping it on or any other method. It is understood that some drilling and other mechanical process is required in order to route the wires to their eventual destination so that they can provide the service they are meant for. There are tools and adapters for each particular wiring case but this subject is beyond the scope of this invention.

1. a method of neatly routing different technologies' types of wires utilizing the herein proposed type of molding.

2. A method according to claim 1 wherein a flat panel directly attached to the wall and houses the various wires and the decorative molding attaches to this panel.

3. A method according to claim 1 wherein the various wires are housed in the molding itself and the molding with the wires attaches to the wall.

4. A method according to methods 2 and 3 wherein channels are etched in either the flat panel or the molding bodies to consequently house the wires.

5. A method according to methods 2 and 3 wherein “snap on” adapters are manufactured on the flat panel or the molding bodies to consequently house the wires.

6. A method according to all methods wherein all wires can be inserted into a clear tube open on one side and consequently inserted either into the snap on adapters or the pre-etched channels of the molding.
